(19) United States
(12) Patent Application Publication
(10) Pub. No.: US 2006/0108060 A1
(43) Pub. Date: May 25, 2006

(54) Fusible web applique and fabrication method thereof

(76) Inventor: Bonnie Benjamin-Shaw, Sonora, CA (US)

Correspondence Address: Bonnie Benjamin-Shaw, 18971 Hess Ave., Sonora, CA, 95370, US

(21) Appl. No.: 11/283,129

(22) Filed: Nov. 17, 2005

Related U.S. Application Data
(60) Provisional application No. 60/629,413, filed on Nov. 19, 2004.

(51) Int. Cl. B29C 65/00

(52) U.S. Cl. 156/256; 156/267; 428/343

(57) ABSTRACT

Fusible adhesive appliqués and methods for manufacturing, marketing, and using fusible adhesive appliquéelements are provided. An aspect of the present invention is the use of precise cutting techniques, which enhance design offerings. Another aspect of the invention is the use of heat-activated adhesives to make the use of appliquéelements more accessible to the average crafter.

### CROSS-REFERENCE TO RELATED APPLICATIONS

The present Utility patent application claims priority benefit of the U.S. provisional application for patent No. 60/629,413, entitled “Fusible Web Appliqué and Method”, and filed on Nov. 19, 2004 under 35 U.S.C. 119(e).

### FEDERALLY SPONSORED RESEARCH OR DEVELOPMENT

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to fabric appliqués. More particularly, the present invention relates to fusible adhesive appliqués and methods for manufacturing, marketing, and using fusible adhesive appliquéelements.

### BACKGROUND OF THE INVENTION

In traditional appliquémethods and systems, fabric is hand cut into shapes. The shapes are stitched to a background material.

The prior art includes a method of fusible appliqué that utilizes fusible web. Fusible web is a web that has a heat-activated adhesive, which can be used to bond fabric layers together or to stiffen or stabilize fabric.

Fusible appliqué as it is known in the prior art can be very time consuming and labor intensive. A crafter or quilter begins with a purchased or homemade pattern of the desired shape of the appliqué. The desired shape is traced onto the fabric to be made into the appliqué, and fusible adhesive layer as needed. The adhesive layer is fused to the appropriate color fabric and the desired shape is hand cut out. Each of the desired shapes must be fused by hand, then hand cut, then fused on the background in the appropriate sequence, allowing the crafter to approximate the look of a hand-sewn appliquédesign. This is a very labor and time intensive process, sometimes taking as long as traditional hand appliquémethods. Because cutting is done by hand, usually with scissors, it is not possible to be very detailed. This method can also be very expensive, as fabrics must be purchased in lengths in excess of what is actually needed, usually with some fabric wasted.

The prior art also involves a less common method of quilting that relies on fusible adhesive applied to one side of an interfacing material, which is printed with a pattern of shapes. The crafter irons the fabric to the adhesive side of the interfacing material and then, in one approach cuts out the shapes as printed on the interfacing material. In another approach, the crafter sews seams through the layer of interfacing and fabric that she has created, approximating the look of a pieced quilt. Again, this is generally a very time consuming process and there is usually excess fabric purchased.

In view of the foregoing, there is a need for an improved fusible web appliqué and method for manufacture that is less labor intensive, easies to perform, and creates less waste.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates exemplary appliquéart elements, in accordance with an embodiment of the present invention; and

FIG. 2 is a flowchart showing exemplary steps of preparation of appliquéelements, for making individually packaged fusible appliqués as well as fusible appliquékits in accordance with an embodiment of the present invention.

Unless otherwise indicated illustrations in the figures are not necessarily drawn to scale.

### SUMMARY OF THE INVENTION

To achieve the foregoing and other objects and in accordance with the purpose of the present invention, a less time consuming and more efficient fusible web appliquéand methods for its use, manufacturing and marketing are provided.

A method for fabricating a fusible web appliquéis provided, which includes the Steps of cutting an appliquématerial (e.g., a fabric or non-fabric) to a desired width corresponding to a fusible adhesive layer, aligning and laminating (e.g., with a heat press, an iron, a fuser with heated roller(s), or a Glenro machine) the adhesive layer (including an adhesive on a non-web medium) with the appliquématerial to form at least one laminated appliquématerial, cutting (e.g., with a laser cutter, hand cutting, a die cutting machine, a flatbed blade cutter, or water jet cutter) the at least one laminated appliquématerial into a suitable size for a desired appliquépattern, cutting a positioned laminated appliquématerial into at least one appliquédesign element. The resulting at least one appliquédesign element, alone or in combination with other appliquédesign element(s), is operable to form an appliquéart (e.g., on a quilt, clothing, a drapery, a pillow, or a bed-skirt).

In some embodiments of the present invention, the fusible adhesive layer has a weak, or no, adhesive, which adhesive must be activated to strongly adhere and is thereby repositionable with respect to the back side of the appliquématerial prior to being activated, which might include the Step of activating the fusible adhesive layer to adhere onto the back side of the appliquématerial at least strong enough to facilitate the appliquématerial cutting.

In one embodiment, precise cutting techniques are used, making the field of appliquéart elements available to more crafters and quilters and expanding it into more detailed offerings for home décor, crafting and quilting markets. By not requiring sewing to create the appliquéart, the art of appliquéis accessible to more crafters. An embodiment of the present invention can also be used for applications such as, but not limited to, quilting, creating borders, embellishing a cornice or drape, edging a bed skirt to match, decorating a pillow, decorating a garment and a variety of other decorative applications. It is an aspect of the present invention that it is well suited for use with fabrics and adhesives that are washable and dry-cleanable.

Some alternate embodiments of the present invention further include the Step of cutting off at least one excess portion of the laminated appliquématerial that is not part of the at least one appliquédesign element, whereby the excess portion may be cut into at least one smaller appliquéelement.

The Step of packaging the at least one appliquéelement with appliquécreation instructions into an appliquékit may be performed in some applications.

In yet other embodiments of the present invention, a fusible web appliquéis provided, which includes an appliquématerial, a fusible adhesive layer laminated onto a back side of the appliquématerial, the at least one laminated appliquématerial being that is configured into an appliquédesign element, the at least one appliquédesign element, alone, or in combination with other appliquédesign element(s), being operable to form an appliquéart. Multiple other embodiments of the present invention may be further realized by implementing any combination of the corresponding design choices provided above in the fabrication method embodiments.

Embodiments of the present invention may be configured to provide fusible adhesive appliqués having a desired shape for attachment to a background material thereby providing a decorative effect to the background material and methods for manufacturing, marketing and using fusible appliquéelements as well as providing the appliquéelements to a crafter or quilter in an appliquékit. An aspect of the manufacturing process of these fusible adhesive appliqués is the use of a laser cutter, which allows for enhanced appliquédesigns. Another aspect of the invention is the use of heat-activated adhesives that make appliqués more accessible to the average person by making them easier to use.

The objectives, features, and advantages of the invention will be more readily understood upon consideration of the following detailed description of the invention taken in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

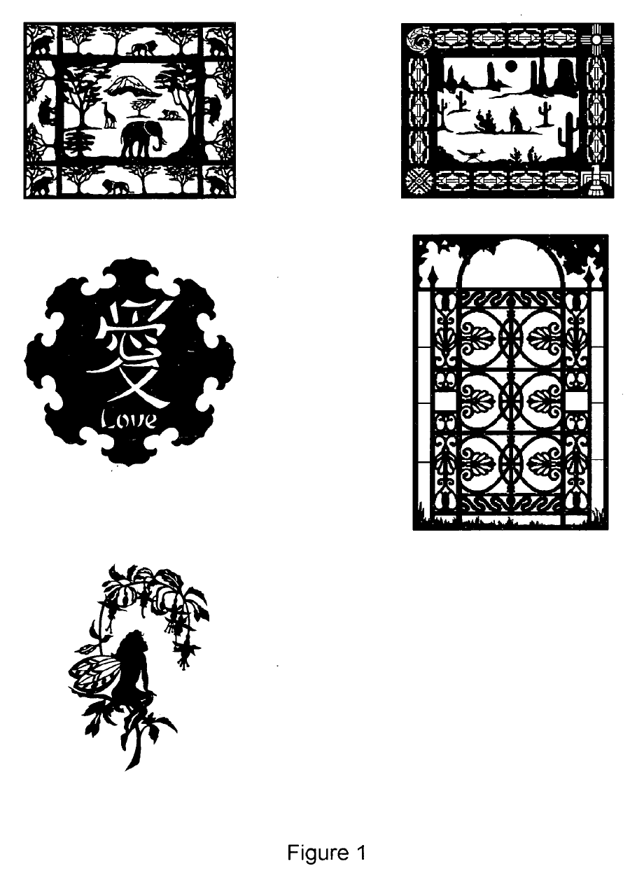

FIG. 1 illustrates exemplary appliquéart elements, in accordance with an embodiment of the present invention. The appliquéelements of the present embodiment make fusible appliquéfast, easy and more accessible for the average crafter or quilter by use of a fusible adhesive layer and at least because they are precut and do not require the quilter or crafter to engage in the tedious process or marking and then cutting the appliqué. The appliquéelements are at least one or a plurality of pre-cut shapes, which, together, present a final appliquéart object.

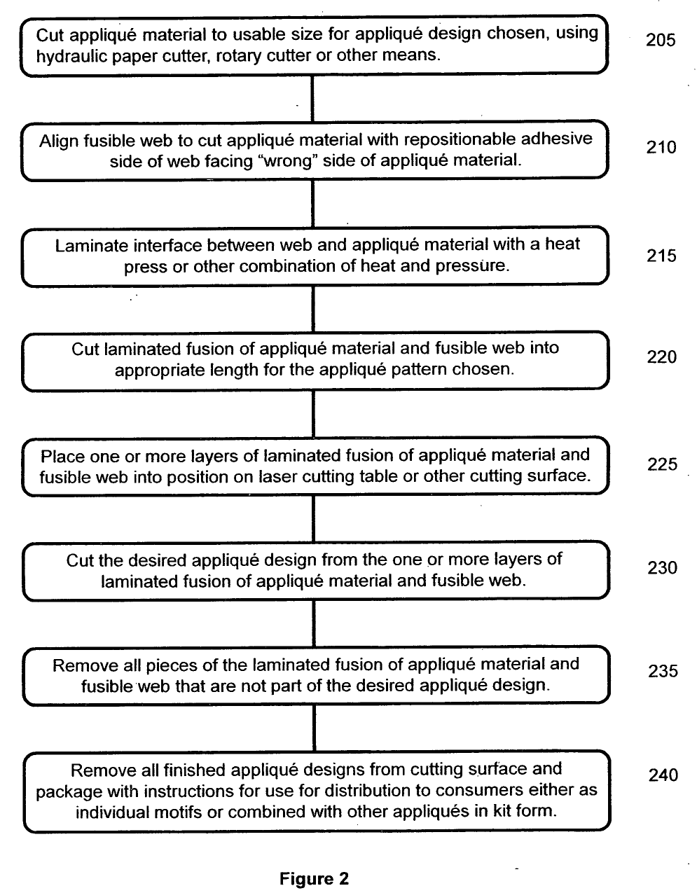

FIG. 2 is a flowchart diagram showing exemplary steps of preparation of appliquéelements, for making individually packaged fusible appliqués as well as fusible appliquékits in accordance with an embodiment of the present invention. In the present embodiment, the appliquéelement is formed from the fusion or lamination of a fusible adhesive layer and a sheet of material, the material having a front face to face outwardly when the appliquéelement has been prepared, and a back face to face against a background material when the appliquéelement is attached to the background material. The back face of the appliquéelement is coated with a heat-activated adhesive integral to the fusible adhesive layer. The material and adhesive fusion is cut to form appliquéelements.

Fusible adhesive web as a suitable adhesive layer for the present embodiment comes in two types. The first is comprised of a very thin sheet of non-repositionable adhesive film that is covered on one side with another repositionable adhesive, which is in turn protected by a release paper. The release paper is non-adhesive. The second type is comprised of a double-sided web with repositionable adhesive on both sides, each protected by a release paper. In some embodiments, the adhesive layer may also be formed of adhesive on a non-web medium.

The preferred embodiment of the present invention is accomplished as set forth below. The appliquéelement material is selected. Usually the appliquéelement material is a fabric such as, but not limited to, cotton, polyester and cotton blends, acetate, polyester, nylon, fabric paper, synthetic suede, and synthetic leather. The present embodiment could also utilize non-fabric materials, such as, but not limited to, leather, paper or wood paper for the appliquéelements. Wood paper is an extremely thin slice of wood having the general thickness of paper, but still shows wood grain. The adhesive application on the fusible adhesive layer is a relatively thin coating. The coatings are such as to maintain a soft, flexible appliquéelement. The inactive adhesive coating is activated after assembly to form an active adhesive that joins the appliquéelements and the background. A preferred adhesive is heat activated to convert the inactive adhesive to a bonding state. Those skilled in the art will recognize other adhesives suitable for use in the present invention based on the teaching of the invention, including, without limitation. In accordance with the present embodiment, the adhesive is selected so as to remain part of the appliquéart, capable of being washed without compromising the attachment of the appliquéelements to the background.

Before the fusing process begins, the appliquéelement material is cut to a workable size. In the preferred embodiment, the workable size is 18 inches wide attained by cutting the material with a hydraulic paper cutter or alternate cutting methods such as, but not limited to, scissors, rotary cutter, manual paper cutter or laser. However, heat presses and laminating machines are known to be capable of accommodating substantially wider materials, and alternate material sizes, such as, but not limited to 22 inches or 45 inches wide, or up to 60″ for some applications, may be suitable in some embodiments. In some cases it may be beneficial, but not necessary, to wash and iron the material at this point, before laminating or fusing it to the fusible adhesive, in order to remove any excess dye or to pre-shrink the fabric.

In step 205 of the present embodiment, the appliquématerial is cut to a size which will be usable with the width of the fusible web by any suitable means including, without limitation, a hydraulic paper cutter, laser or rotary cutter. This width may vary depending on the appliquédesign to be made.

In step 210 of the present embodiment, a fusible adhesive layer is aligned to the back side, also known as the “wrong ” side, of the material that will become the appliquéby attaching the repositionable adhesive side against the material. The fusible adhesive web is typically very thin, so it comes on a paper liner, also commonly referred to as a “carrier sheet”, which stiffens the fusible web for better handling. The paper liner is left in place throughout the cutting process. The crafter or quilter will peel it off before fusing the appliquéelements to a background material. The material and adhesive layer are aligned, and, in step 210, they are pulled simultaneously through a laminating process.

In step 215 of the present embodiment, the lamination of the fusible adhesive and the appliquématerial is achieved. The process used in the present embodiment is a heat press, and the method of operation of the heat press is known. However, those skilled in the art will recognize a multiplicity of alternate fusing methods such as, but not limited to irons, fusers with heated rollers, and laminating machines such as a Glenro (see http://www.glenro.com/LamSys/LamCONT.htm), pressure with no heat. Ironing at this stage of manufacture is less desirable for large pieces, as it is slower, but may be preferentially used for odd-sized or smaller pieces of adhesive layer and material to minimize waste. Also, when the crafter or quilter is completing the appliquéart, ironing is the preferred method to heat-activate the adhesive. In the present embodiment, the inactive adhesive is preferably a heat-activated material that is readily activated by the heat of a typical well-known hot ironing unit used for pressing clothing. However, other energy or other activated adhesives may be used depending upon the needs of the particular application, and are considered as within the scope of the invention. Enough heat is applied for sufficient time to activate the adhesive on the fusible adhesive layer and adhere it to the material. The time of fusing and temperature of heat varies depending on the type of material being used, the objective being to laminate the fusible web adhesive to the fabric so that it sticks together while being cut. The result is a material and adhesive layer fusion. The protective release paper, or carrier sheet, may remain on the fusion, as it makes it stiffer and easier to handle.

After the fusible web and the material have been laminated, it is cut to a workable size in step 220. The size varies according to the particular appliquédesign being created. In step 225 one or more layers of the fusion are placed into the correct position on the laser cutting table. Then in step 230, the material and adhesive layer fusion are cut into appliquéelements of various shapes, which, when assembled together, will form the appliquéart. In the present embodiment, cutting is accomplished with a laser cutter, but those skilled in the art, in light of the present teaching, will recognize other appropriate methods for cutting the fusion such as, but not limited to, hand cutting, a die cutting machine, or flatbed blade cutter or water jet cutter A laser cutter is the preferred method because it is fast and allows the appliquéelements to be cut in much more intricate designs than would be possible with other cutting methods. In FIG. 230, the fusion is placed on the bed of a laser-cutting machine, and can be layered so that multiple sheets can be cut at once. In the preferred embodiment, depending on the type of fabric being used, the fusion is stacked one to three layers thick. In some embodiments, the fusion may be stacked in mores layers, but with fewer layers, the fusion can be cut faster with typically less burn. The machine operator selects a pre-programmed cutting design, and enters the specifications of the material and adhesive layer fusion. A test paper is optionally pre-aligned under the material and adhesive layer fusion to protect the table under the fusion and to allow verification that the laser has penetrated all the layers of the fusion. After the laser has completed its cut, the fusion is removed from the laser machine.

In FIG. 235 portions of the fusion that are not part of the appliquéelements are commonly referred to as “slugs”. These slugs are preferably removed from around the desired appliquéelements. Slugs may be used by cutting them into smaller appliquéelements to minimize waste, or they may be sold, since any material with fusible adhesive applied to it has value to the consumer.

In FIG. 240 the appliquéelements may then optionally be packaged with instructions individually or combined together with other appliqués to create appliquékits or otherwise made available to quilters and crafters. The present embodiment provides an appliquéart kit assembly comprising various elements of appliquéart that have already been cut and prepared for ready application and an instruction sheet for creating appliquéart. This art may be used in any textile media such as, but not limited to, quilts, clothing, or other such suitable media such as home decor items like draperies, pillows, bed-skirts. The crafter applies the appliquéelements to a background material. The present embodiment permits the crafter to reduce the time to complete the appliquéart and particularly eliminates the time consuming and tedious steps of cutting appliquéelements, temporarily connecting the elements to the background, sewing the appliquéelements to the background, and removing the temporary attachments.

In the present embodiment, the instructions included in the appliquékit in step 240 will instruct the crafter to place the appliquéelement on the background material with the back face against the background and with the front face of the appliquéelement facing outwardly. The crafter will select a background material to which the appliquéelements are to be attached. The background material is normally a cloth, but may also be some other type of material such as, but not limited to, paper, fabric paper or wood. The crafter is further instructed to apply heat from a heat source such as, but not limited to, an iron over the front face to soften the heat-activated adhesive thereby adhering the appliquéelement to the background. In other embodiments of the present invention, fully or partially completed appliquédesigns suitable for particular applications are provided instead of just the kits.

There are at least two alternate methods contemplated for laser cutting the appliquédesign depending on the finished look desired. In some embodiments of the present invention using a first alternate method, an appliquéelement recreates the look of pieced quilt patterns. Each appliquéelement is cut out individually. The crafter need only peel the backing paper off the element, finger press it in place, allowing the repositionable adhesive to hold it in place until all pieces are correctly in position and then press with an iron to form a permanent bond. In other embodiments using a second alternate method, the appliquéelements can be used to recreate the look of appliquéquilt designs, which typically have many small pieces, by leaving each piece tabbed into the background fabric. The crafter snips the tabs, freeing the smaller appliquéelement pieces, and proceeds as above with the peel, place and press steps. It should be noted that while many of the forgoing examples and embodiments have been directed to quilting, however, embodiments of the present invention are contemplated to comprise a much greater scope of applications as will be readily recognized by those skilled in the art; by way of example, and not limitation, an appliquéof the present invention could be adapted in embodiments suitable to be put on a jacket.

Those skilled in the art will readily recognize, in accordance with the teachings of the present invention, that any of the foregoing steps and/or exemplary tooling may be suitably replaced, reordered, removed and additional steps and/or other suitable tooling may be inserted depending upon the needs of the particular application, and that the systems of the foregoing embodiments may be implemented using any of a wide variety of suitable processes and machinery, and is not limited to any particular means to carry out the foregoing steps.

The terms and expressions which have been employed in the forgoing specification are used therein as terms of description and not of limitation, and there is no intention in the use of such terms and expressions of excluding equivalence of the features shown and described or portions thereof.

Having fully described at least one embodiment of the present invention, other equivalent or alternative approaches for providing a fusible web appliquéand methods for its use, manufacturing and marketing according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for fabricating a fusible web appliqué, the method comprising the Steps of:
cutting an appliquématerial to a desired width corresponding to a fusible adhesive layer;
aligning said fusible adhesive layer with a back side of the appliquématerial;
laminating said adhesive layer with the appliquématerial to form at least one laminated appliquématerial;
cutting said at least one laminated appliquématerial into a suitable size for a desired appliquépattern;
positioning said sized at least one laminated appliquématerial on a cutting apparatus in an arrangement corresponding to the desired appliquépattern; and
cutting said positioned at least one laminated appliquématerial into at least one appliquédesign element, said at least one appliquédesign element, alone or in combination with other appliquédesign element(s), is operable to form an appliquéart.

2. The method for appliquéfabrication of claim 1, wherein cutting an appliquématerial is done a hydraulic paper cutter, laser or rotary cutter.

3. The method for appliquéfabrication of claim 1, wherein said fusible adhesive layer has a weak, or no, adhesive, which adhesive must be activated to strongly adhere and is thereby repositionable with respect to the back side of the appliquématerial prior to being activated.

4. The method for appliquéfabrication of claim 3, further comprising the Step of activating said fusible adhesive layer to adhere onto the back side of the appliquématerial at least strong enough to facilitate said appliquématerial cutting.

5. The method for appliquéfabrication of claim 1, wherein said lamination of said adhesive layer with the appliquématerial is by way of a heat press, an iron, a fuser with heated or unheated pressure roller(s), or a Glenro machine.

6. The method for appliquéfabrication of claim 1, wherein said cutting is accomplished with a laser cutter, hand cutting, a die cutting machine, a flatbed blade cutter, or water jet cutter.

7. The method for appliquéfabrication of claim 1, further comprising the Step of cutting off at least one excess portion of said laminated appliquématerial that is not part of said at least one appliquédesign element.

8. The method for appliquéfabrication of claim 7, further comprising the Step of cutting said excess portion into at least one smaller appliquéelement.

9. The method for appliquéfabrication of claim 1, further comprising the Step of packaging said at least one appliquéelement with appliquécreation instructions into an appliquékit.

10. The method for appliquéfabrication of claim 1, further comprising the Step of configuring said at least one appliquéelement with a quilt, clothing, a drapery, a pillow, or a bed-skirt.

11. The method for appliquéfabrication of claim 1, wherein said adhesive layer is formed of adhesive on a non-web medium.

12. The method for appliquéfabrication of claim 1, wherein said appliquématerial comprises a non-fabric material.

13. The method for appliquéfabrication of claim 12, wherein, said non-fabric material is leather, paper or wood paper.

14. A fusible web appliquécomprising:
an appliquématerial;
a fusible adhesive layer laminated onto a back side of the appliquématerial, said at least one laminated appliquématerial being that is configured into an appliquédesign element, said at least one appliquédesign element, alone, or in combination with other appliquédesign element(s), being operable to form an appliquéart.

15. The appliquéof claim 14, wherein said fusible adhesive layer has a weak, or no, adhesive, which adhesive must be activated to strongly adhere and is thereby repositionable with respect to the back side of the appliquématerial prior to being activated.

16. The appliquéclaim 14, wherein said at least one appliquéelement is a packaged with appliquécreation instructions in an appliquékit.

17. The appliquéof claim 14, in which said at least one appliquéelement is configuring onto a quilt, clothing, a drapery, a pillow, or a bed-skirts.

18. The appliquéof claim 14, in which said adhesive layer is comprised of an adhesive on a non-web medium.

19. The appliquéof claim 14, in which said appliquématerial comprises a non-fabric material.

20. The appliquéof claim 19, in which said non-fabric material is leather, paper or wood paper.
